(19) United States
(12) Patent Application Publication
(10) Pub. No.: US 2010/0067784 A1
(43) Pub. Date: Mar. 18, 2010

(54) CONVERSION TO MONOCHROME IMAGE

(76) Inventor: Ali Alsam, London (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/556,183

(22) Filed: Sep. 9, 2009

(30) Foreign Application Priority Data
Sep. 9, 2008 (GB) 0816456.8

(51) Int. Cl. G06K 9/00; H04N 1/40; H04N 9/04

(52) U.S. Cl. 382/163; 358/3.01; 348/223.1; 348/E09.002

(57) ABSTRACT

Provided is a method of obtaining a monochrome image from a color image, said color image comprising a plurality of color pixels, and having at least two color channels, each pixel of said plurality of color pixels comprising a value for each color channel of said at least two color channels, said monochrome image comprising a plurality of monochrome pixels, each monochrome pixel having a value for a monochrome channel, the method comprising:
calculating a local weighting factor for each color channel of each pixel of said color image;
calculating said value of said monochrome channel for each pixel as a sum over said at least three color channels of products of said local weighting factor and said value for each color channel.

### FIELD OF THE INVENTION

The present invention relates generally to the field of image processing, and more specifically to the conversion of a multichannel image to a monochromatic image.

### BACKGROUND

It is often desirable to convert a multichannel image such as a color image to a monochrome image. This may, for example, be for artistic reasons. Generally conversion from a color image to a monochrome or grayscale image is achieved by multiplying the individual channels of the color image by weighting factors and adding the weighted color channels together for each pixel to give a gray channel value for each pixel of an image. For example the following equation is used in the NTSC scheme for color television in the United States to calculate the Y-luminance:

Y=0.30*R+0.59*G+0.11*B

Where R is the value of the red channel, G is the value of the green channel and B is the value of the blue channel.

Conversion from color images to monochrome images using the above method may result in the loss of chrominance edges not represented in the luminance channel.

U.S. Pat. No. 6,473,521 shows a method of conversion from a color image to a grayscale image. When performing the grayscale conversion, color data of objects in the color image is stored and color data of an object adjacent to an object to be processed is referred to. As a result of such reference, when it is detected that the object to be processed and the object adjacent to the object to be processed have different colors, but are converted to the same density by the grayscale conversion, the grayscale conversion is performed in such a manner that the boundary between the objects can be identified. This is achieved by generating a difference in the grayscale converted value of the objects.

### SUMMARY OF THE INVENTION

In accordance with an embodiment of the present invention there is provided a method of obtaining a monochrome image from a color image. The color image comprises a plurality of color pixels and has at least two color channels, each pixel of the plurality of pixels comprises a value for each color channel of the at least two color channels. The monochrome image comprises a plurality of monochrome pixels each pixel has a value for a monochrome channel. The method comprises calculating a local weighting factor for each color channel of each pixel of the color image. The method further comprises calculating the value of the monochrome channel for each pixel as a sum over the at least two color channels of the products of the local weighting factor and the value for each color channel.

Embodiments of the present invention are particularly advantageous as all color edges in the color image are preserved in the monochrome image. Thus, methods consistent with embodiments of the present invention result in monochrome or grayscale images having maximized contrast. Further, embodiments of the present invention provide a method of conversion from a color image to a monochrome image which is non-iterative and uses only local computations. Therefore methods consistent with embodiments of the present invention can be effectively implemented on simple hardware.

In accordance with an embodiment of the present invention, the local weighting factors are calculated from a local intensity difference value of each color channel of each pixel with a mean channel level.

In accordance with an embodiment of the present invention, the mean channel level is calculated from a normalized sum over the at least two color channels over a region around a pixel under consideration.

In accordance with an embodiment of the present invention, the normalized sum is spatially weighted.

In accordance with an embodiment of the present invention, the local intensity difference value for a color channel of the at least two color channels is calculated by a subtraction of the mean channel level from the value for the color channel.

In accordance with an embodiment of the present invention, the at least two color channels comprise a red channel, a green channel, and a blue channel.

In accordance with an embodiment of the present invention, the color image is a multi-spectral image.

In accordance with an embodiment of the present invention, there is provided an image processing system. The image processing system comprises a weighting factor calculation module operable to calculate a local weighting factor for each color channel of each pixel of a color image. The image processing system further comprises a monochrome channel calculation module for calculating a monochrome channel value for each pixel as a sum of the products of the local weighting factor of each color channel and a pixel value of that color channel.

In accordance with an embodiment of the present invention, there is provided a computer program product comprising computer executable instructions for performing a method for calculating a value for a monochrome pixel at a location in a monochrome image from a color image. The color image comprises a plurality of pixels and has at least two color channels, each pixel of the color image has a value for each color channel. The method comprises calculating a mean channel value for a block of pixels in a region surrounding a location on the color image corresponding to the location of the monochrome pixel. The method further comprises computing a difference between a pixel of the color image at the location on the color image and the mean channel value. The method further comprises calculating a weighting factor for each color channel from the difference. The method further comprises calculating the value of the monochrome pixel as a sum of the products for each color channel of the weighting factor and the value for that color channel of the pixel at said location on the color image.

### BRIEF DESCRIPTION OF THE DRAWINGS

In the following, embodiments of the invention will be described, by way of example only, and with reference to the drawings in which:

FIG. 1 shows a schematic view of a color image,

FIG. 2 shows a schematic view of a monochrome image,

FIG. 3 shows a block diagram of an image processing system,

FIG. 4 shows a flow diagram illustrating steps involved in a method of converting a color image to a monochrome image,

FIG. 5 shows a flow diagram illustrating steps involved in a method of converting a color image to a monochrome image.

### DETAILED DESCRIPTION

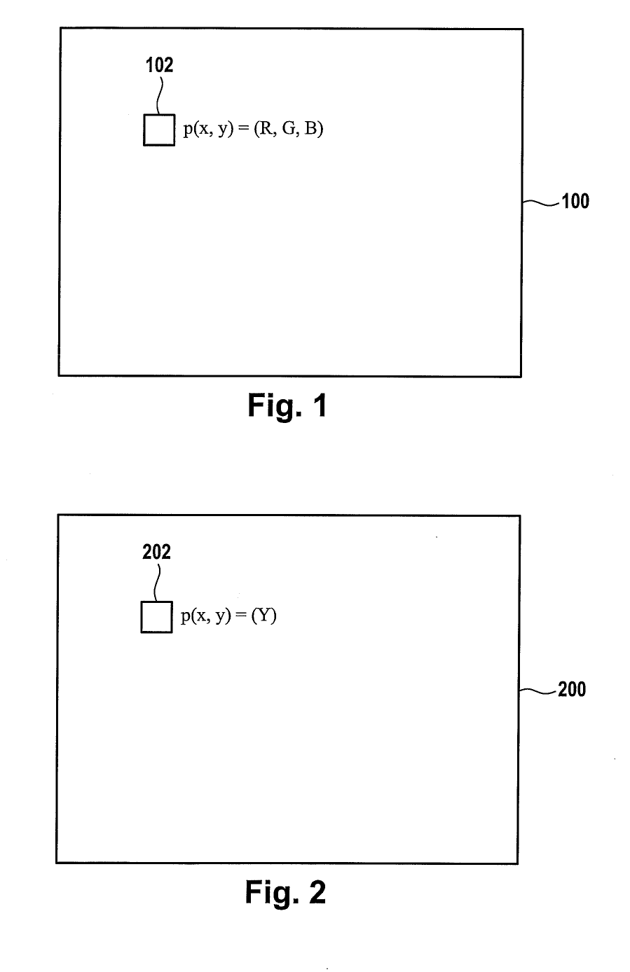

FIG. 1 shows a schematic view of a color image 100. Color image 100 comprises a plurality of pixels. Pixel 102 at location (x, y) has values for a red channel, R a green channel, G and a blue channel, B. Image 100 is formed from a number of pixels each having three values R, G, and B indicating the values of the three color channels.

FIG. 1 shows image 100 having pixels such as 102 with three color channels, however images having two color channels or images having a number of color channels greater than three may also be processed and converted into a monochrome image using methods and systems consistent with embodiments of the present invention. For example, the present invention may be used to convert a multi-spectral image having a large number of color channels which may be within the visible range and may also be outside the visible range.

FIG. 2 shows a schematic view of a monochrome image 200. Monochrome image 200 comprises a number of pixels each having a single color channel. Pixel 202 at the location (x, y) has a single color channel with the value Y.

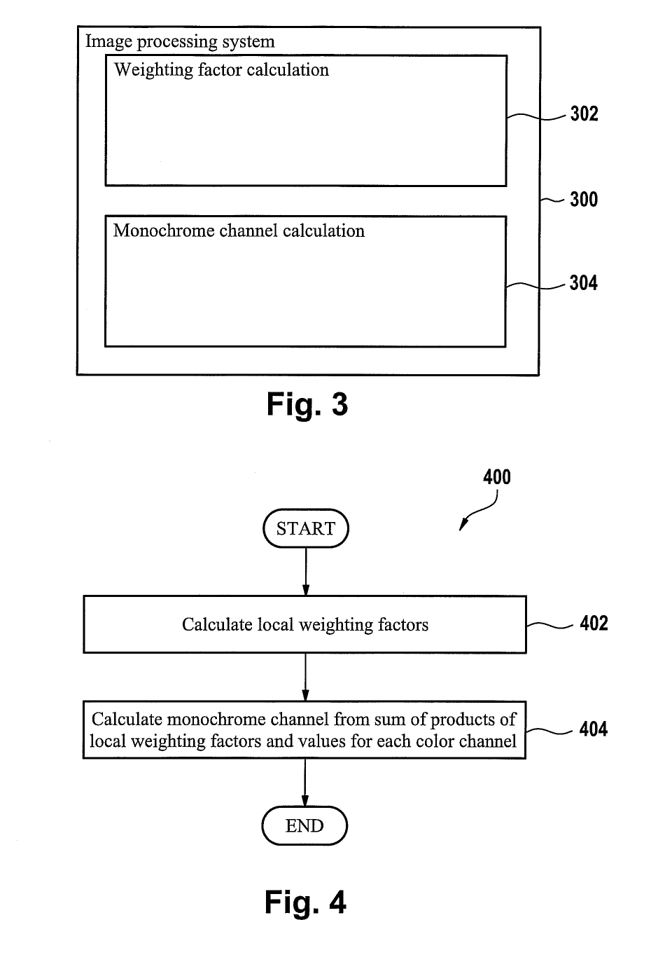

FIG. 3 shows an image processing system 300 for converting a color image such as that shown in FIG. 1 to a monochrome image such as that shown in FIG. 2. Image processing system 300 comprises weighting factor calculation module 302 and monochrome channel calculation module 304. Weighting channel calculation module 302 is operable to calculate a local weighting factor for each color channel of each pixel of a color image. Thus taking color image 100 in FIG. 1 as an example, weighting factor calculation module 302 would calculate for each pixel a weighting factor for the red channel, the green channel and the blue channel. Monochrome channel calculation module 304 uses the local weighting factors calculated by weighting factor calculation module 302 to calculate a monochrome or gray channel value for each pixel of the monochrome image. The monochrome channel calculation module 304 calculates the monochrome channel value for each pixel as a sum of the products of the local weighting factor of each color channel and the pixel value of that color channel.

Image processing system 300 facilitates the conversion of a color image to a monochrome image in which the monochrome image preserves all color edges of the color image. This is achieved by the calculation of local weighting factors by weighting factor calculation module 302. Local calculation of the weighting factors allows contrasts in any one of the color channels between adjacent pixels to be preserved in the monochrome image.

Image processing system 300 may be realized as a computer system with the weighting factor calculation module 302 and the monochrome channel calculation module 304 implemented as software or hardware components. These may be implemented as a stand-alone program, or as a plug in or add on to an image processing application. Image processing system 300 may further be implemented as a component within an image capture device such as a digital camera or a scanner. Image processing system 300 may further be implemented as a component within a printer. In such a case, the printer may receive a color image and produce a monochrome image for subsequent printing.

FIG. 4 shows a method 400 for converting a color image such as that shown in FIG. 1 to a monochrome image such as that shown in FIG. 2. In step 402, local weighting factors are calculated. In step 402 a weighting factor for each color channel is calculated locally based on intensity difference values or contrast values with neighboring pixels. In step 404, the monochrome or gray channel is calculated from the sum of products of the local weighting factors calculated in step 403 and the values for each color channel.

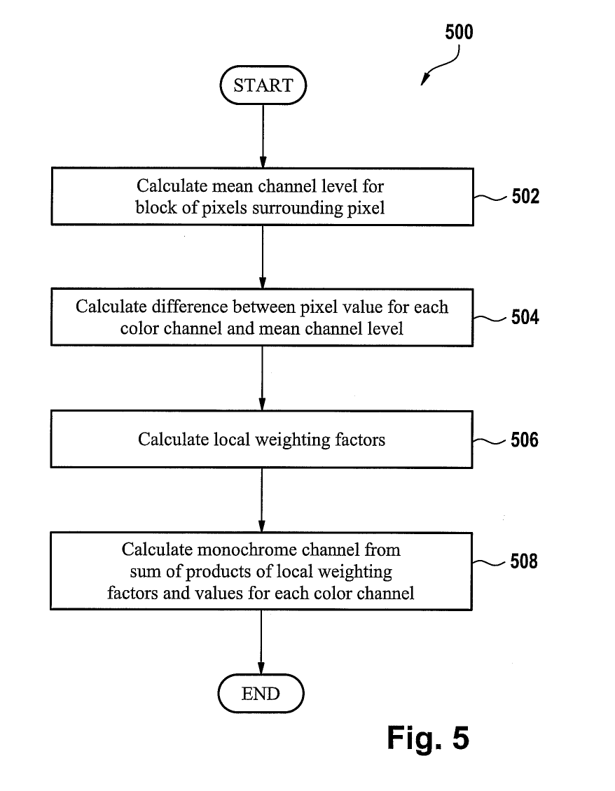

FIG. 5 shows a method 500 of converting a color image to a monochrome image. In step 502 a mean channel level for a block of pixels surrounding the pixel in question is calculated. The mean channel level is calculated in order to measure a local contrast for each pixel of the pixel in question in the color image with the surrounding pixels in the neighborhood. The mean channel level may be calculated according to the following formula:

MΣ=(R+G+B)/3

Where the sum is a normalized summation performed over a neighborhood defined around the pixel under consideration, and R, G and B are the values of the red, green and blue channels respectively. The summation may be spatially weighted with pixels in the region surrounding the pixel in question being weighted according to for example their distance from the pixel in question.

The region over which the mean channel level is calculated for comparison with the values of each color channel of the pixel in question may be defined by a user input. The region over which a mean channel level is calculated may vary from a square of 3×3 pixels surrounding the pixel in question to a block as large as a quarter of the color image. The shape of the region may also be varied for example it may be a square, a circle, or other shape.

In step 504, the difference between the pixel value for each color channel of the pixel under consideration and the mean gray level calculated in step 502 is calculated. Thus a local contrast measure or intensity difference value for each color channel is obtained. In the case of three color channels the local intensity difference values are as follows:

Cᵣ=|″R−M||

C_{g}=||G−M||

C_{b}||B−M||

Where Cᵣ, C_{g} and C_{b} are the local contrast values, or intensity difference values for the red, green and blue channels respectively.

From the local intensity difference values obtained in step 506, the local weighting factors for a pixel are calculated. The local weighting factors may be calculated according to the following formulae:

a=Cᵣ/(Cᵣ+C_{g}+C_{b});

b=Cᵣ/(Cᵣ+C_{g}+C_{b});

c=C_{b}/(Cᵣ+C_{g}+C_{b})

Where a is the local weighting factor for the red channel, b is the local weighting factor for the green channel and c is the local weighting factor for the blue channel.

It is noted the local weighting factors calculated using the above formulae sum to one.

Using the local weighting factors calculated in step 508, the gray or monochrome channel may be calculated as the sum of the products of the local weighting factors with the values for each color channel in step 508. The calculation in step 508 may be made according to the following formula:

Y=aR+bG+cB

The method described above may be implemented as a hardware embodiment, a software embodiment, or a combination of the two. The method may be implemented as a computer program product containing computer readable instructions which when executed on a computer or image processing device cause the computer or image processing device to execute the methods described above.

### LIST OF REFERENCE NUMERALS

100 color image

102 color pixel

200 monochrome image

202 monochrome pixel

300 image processing system

302 weighting factor calculation module

304 monochrome channel calculation module

400 method

402 calculate local weighting factors

404 calculate monochrome channel

500 method

502 calculate mean channel level

504 calculate difference between pixel value and mean channel level

506 calculate local weighting factors

508 calculate monochrome channel

What is claimed is:

1. A method of obtaining a monochrome image from a color image, said color image comprising a plurality of color pixels, and having at least two color channels, each pixel of said plurality of color pixels comprising a value for each color channel of said at least two color channels, said monochrome image comprising a plurality of monochrome pixels, each monochrome pixel having a value for a monochrome channel, the method comprising:
calculating a local weighting factor for each color channel of each pixel of said color image;
calculating said value of said monochrome channel for each pixel as a sum over said at least two color channels of products of said local weighting factor and said value for each color channel.

2. The method of claim 1, said local weighting factors being calculated from a local intensity difference value of each color channel of each pixel with a mean channel level.

3. The method of claim 2, said mean channel level being calculated from a normalized sum over said at least two color channels over a region around a pixel under consideration.

4. The method of claim 3, said normalized sum being spatially weighted.

5. The method of claim 2, said local intensity difference value for a color channel of said at least two color channels being calculated by a subtraction of said mean channel level from said value for said color channel.

6. The method claim 1, said at least two color channels comprising a red channel, a green channel and a blue channel.

7. The method of claim 1, said color image being a multispectral image.

8. An image processing system comprising:
a weighting factor calculation module operable to calculate a local weighting factor for each color channel of each pixel of a color image;
a gray channel calculation module for calculating a monochrome channel value for each pixel as a sum of products of said local weighting factor of each color channel and a pixel value of that color channel.

9. The image processing system of claim 8, said weighting factor calculation module being further operable to calculate a local intensity difference value of each color channel of each pixel with a mean channel level, and to calculate said local weighting factors from said local intensity difference value.

10. The image processing system of claim 9, said weighting factor calculation module being further operable to calculate said mean channel level from a normalized sum over said color channels of said color image over a region around a pixel under consideration.

11. The image processing system claim 8, said color image comprising three color channels.

12. The image processing system of claim 8, said color image being a multispectral image.

13. The image processing system of claim 8, being a printer and further comprising a printing module for printing the monochrome image.

14. The image processing system of claim 8, being an image capture device and further comprising an image capture module for capturing the color image.

15. The image processing system of claim 14, said image capture device being a digital camera.

16. A computer program product comprising computer executable instructions for performing a method for calculating a value for a monochrome pixel at a location in a monochrome image from a color image, said color image comprising a plurality of pixels, and having at least two color channels, each pixel of said color image having a value for each color channel, the method comprising:
calculating a mean channel value for a block of pixels in a region surrounding a location on said color image corresponding to said location of said monochrome pixel;
computing a difference between a pixel of said color image at said location on said color image and said mean channel value;
calculating a weighting factor for each color channel from said difference;
calculating said value for said monochrome pixel as a sum of products for each color channel of said weighting factor and said value for that color channel of said pixel at said location on said color image.

17. The computer program product of claim 16, said mean channel value being calculated as a normalized sum of said values of said pixels of said block of pixels over said at least two color channels.

18. The computer program product of claim 17, said normalized sum being weighted over said block.

19. The computer program product of claim 16, said at least two color channels comprising a red channel, a green channel and a blue channel.

20. The computer program product of claim 16, said color image being a multispectral image.
